(19) United States
(12) Patent Application Publication
(10) Pub. No.: US 2008/0249190 A1
(43) Pub. Date: Oct. 9, 2008

(54) Pesticide Compositions

(76) Inventors: Jeffrey Lee Jensen, Brownsburg, IN (US); Michelle Sprint Smith, Carmel, IN (US); James Edward King, Carmel, IN (US)

Correspondence Address: DOW AGROSCIENCES LLC, 9330 ZIONSVILLE RD, INDIANAPOLIS, IN, 46268, US

(21) Appl. No.: 10/593,699

(22) PCT Filed: Mar. 18, 2005
(86) PCT No.: PCT/US2005/009219

§ 371 Date: Sep. 19, 2006

Related U.S. Application Data
(60) Provisional application No. 60/554,849, filed on Mar. 19, 2004.

(51) Int. Cl. A01N 25/00; A01P 7/04

(52) U.S. Cl. 514/777

(57) ABSTRACT

This invention is related to the field of compositions useful in the control of pests, for example, insects (such as cock-roaches, termites, and ants) and rodents (such as rats and mice), where such compositions comprise soynuts, a non-monosaccharide sugar, and a pesticide.

This application claims a priority based on provisional application 60/554,849 which was filed in the U.S. Patent and Trademark Office on Mar. 19, 2004, the entire disclosure of which is hereby incorporated by reference. This invention is related to the field of compositions useful in the control of pests, for example, insects (such as cockroaches, termites, and ants) and rodents (such as rats and mice).

Anaphylaxis is a severe allergic reaction to certain allergens. Anaphylaxis can, in untreated and severe cases, lead to death by suffocation. One main source of anaphylaxis is allergic reactions to certain foods. Experts estimate that 2.5 percent of the U.S. population has food allergies. 1 percent of the U.S. population is allergic to peanuts or tree nuts alone. Some 125 people in the U.S. die from anaphylaxis caused by food allergies every year.

The pest control industry uses peanut butter as an almost universal pest attractant, such as, using it in baits to attract and kill pests. Several years ago, Canadian pest management professionals stopped using peanut butter baits in pest control when the pest problem occurred in day cares, schools, and homes where children live. (See “Peanut Allergies and Pest Management” by R. Corrigan in Pest Control Technology, pages 98-99, June 2003).

Generally, in order for a bait to be practical the bait must be: (1) easy to store and keep fresh; and (2) easy to use and apply. Baits have been very successful in controlling most pest problems. This is especially true in the area of cockroach control. In fact, controlling cockroaches with baits has become the primary method to handle cockroach problems.

However, cockroaches learn fast from their environment and adapt rapidly. For example, a few years ago, roaches were found to have developed an aversion to glucose in the MAXFORCE® (Trademark of Bayer Environmental Science) bait stations. Here the solution was replace the glucose in the system with another sugar complex. Recently, however, it appears cockroaches have developed an aversion to the baits themselves regardless of the manufacturer. Solving this problem is very difficult, as one senior researcher recently said “It's hard to know what to change [in a bait] when you don't know what the problem is”. (See “Stayin' Alive” by B Harbison, R. Kramer, and J. Dorsch in Pest Control Technology, pages 24-26, 28-29, and 83, January 2003).

This invention provides absolution to the problems summarized above.

This invention provides pesticide compositions useful in the control of pests, for example, insects (such as cockroaches, termites, and ants) and rodents (such as rats and mice) where such compositions comprise soynuts, a non-monosaccharide sugar, and a pesticide.

### Pests

The inventive compositions are useful in controlling pests. For example, insects (such as cockroaches, termites, and ants) and rodents (such as rats and mice).

Further examples are:

(1) the order Lepidoptera for example, Acleris spp., Adoxophyes spp., Adoxophyes reticulana; Aegeria spp., Agrotis spp., Agrotis spinifera; Alabama argiliaceae, Amylois spp., Anticarsia gemmatalis, Archips spp., Argyrotaenia spp., Autographa spp., Busseola fusca, Cadra cautella, Carposina nipponensis, Chilo spp., Choristoneura spp., Clysia ambiguella, Cnaphalocrocis spp., Cnephasia spp., Cochylis spp., Coleophora spp., Crocidolomia binotalis, Cryptophlebia leucotreta, Cydia spp., Cydia pomonella; Diatraea spp., Diparopsis castanea, Earias spp., Ephestia spp., E. Khuniella; Eucosma spp., Eupoecilia ambiguella, Euproctis spp., Euxoa spp, Grapholita spp., Hedya nubiferana, Heliothis spp., H. Virescens und H. zea; Hellula undalis, Hyphantria cunea, Keiferia lycopersi cella, Leucoptera scitella, Lithocollethis spp., Lobesiaspp, Lymantria spp., Lyonetia spp., Malacosoma spp., Mamestra brassicae, Manduca sexta, Operophtera spp., Ostrinia nubilalis, Pammene spp., Pandemis spp., Panolis flammea, Pectinophora spp., Phthorimaea operculella, Pieris rapae, Pieris spp., Plutella xylostella, Prays spp., Scirpophaga spp., Sesamia spp., Sparganothis spp., Spodopteralittoralis, Synanthedon spp., Thaumetopoea spp., Tortrix spp., Trichoplusia ni and Yponomeuta spp.;

(2) the order Coleoptera, for example Agriotes spp., Anthonomus spp., Atomaria linearis, Chaetocnema tibialis, Cosmopolites spp., Curculio spp., Dermestes spp., Diabrotica spp., Epilachna spp., Eremnus spp., Leptinotarsa decemlineata, Lissorhoptrus spp., Melolontha spp., Oryzaephilus spp., Otiorhynchus spp., Phlyctinus spp., Popillia spp., Psylliodes spp., Rhizopertha spp., Scarabeidae, Sitophilus spp., Sitotroga spp., Tenebrio spp., Tribolium spp. and Trogoderma spp.;

(3) the order Isoptera, for example Reticulitermes spp.;

(4) the order Psocoptera, for example Liposcelis spp.;

(5) the order Anoplura, for example Haematopinus spp., Linognathus spp., Pediculus spp., Pemphigus spp. and Phylloxera spp.;

(6) the order Mallophaga, for example Damalinea spp. and Trichodectes spp.;

(7) the order Thysanoptera, for example Frankliniella spp., Hercinothrips spp., Taeniothrips spp., Thrips palmi, Thrips tabaci and Scirtothrips aurantii;

(8) the order Heteroptera, for example Cimex spp., Distantiella theobroma, Dysdercus spp., Euchistus spp. Eurygaster spp. Leptocorisa spp., Nezara spp., Piesma spp., Rhodnius spp., Sahlbergella singularis, Scotinophara spp. and Triatoma spp.;

(9) the order Homoptera, for example Aleurothrixus floccosus, Aleyrodes brassicae, Aonidiella aurantii, Aphididae, Aphis craccivora, A. fabae, A. gosypii; Aspidiotus spp., Bemisia tabaci, Ceroplaster spp., Chrysomphalus aonidium, Chrysomphalus dictyospermi, Coccus hesperidum, Empoasca spp., Eriosoma lanigerum, Erythroneura spp., Gascardia spp., Laodelphax spp., Lecanium comi, Lepidosaphes spp., Macrosiphus spp., Myzus spp., M. persicae; Nephotettix spp., N. cincticeps; Nilaparvata spp., N. lugens; Paratoria spp., Pemphigus spp., Planococcus spp., Pseudaulacaspis spp., Pseudococcus spp., P. Fragilis, P. citriculus and P. comstocki; Psylla spp., P. pyri; Pulvinaria aethiopica, Quadraspidiotus spp., Rhopalosiphum spp., Saissetia spp., Scaphoideus spp., Schizaphis spp., Sitobion spp., Trialeurodes vaporariorum, Trioza erytreae and Unaspis citri;

(10) the order Hymenoptera, for example Acromyrmex, Atta spp., Cephus spp., Diprion spp., Diprionidae, Gilpinia polytoma, Hoplocampa spp., Lasius spp., Monomorium pharaonis, Neodiprion spp., Solenopsis spp. and Vespa spp.;

(11) the order Diptera, for example Aedes spp., Antherigona soccata, Bibio hortulanus, Calliphora erythrocephala, Ceratitis spp., Chrysomyia spp., Culex spp., Cuterebra spp., Dacus spp., Drosophila melanogaster, Fannia spp., Gastrophilus spp., Glossina spp., Hypoderma spp., Hyppobosca spp., Liriomyza spp., Lucilia spp., Melanagromyza spp., Musca spp., Oestrus spp., Orseolia spp., Oscinella frit, Pegomya hyoscyami, Phorbia spp., Rhagoletis pomonella, Sciara spp., Stomoxys spp., Tabanus spp., Tannia spp. and Tipula spp.;

(12) the order Siphonaptera, for example Ceratophyllus spp. and Xenopsylla cheopis;

(13) the order Thysanura, for example Lepima saccharina and from the order Acarina, for example Acarus siro, Aceria sheldoni; Aculus spp., especially A. schlechtendali; Amblyomma spp., Argas spp., Boophilus spp., Brevipalpus spp., especially B. californicus and B. phoenicis; Bryobia praetiosa, Calipitrimerus spp., Chorioptes spp., Dermanyssus gallinae, Eotetranychus App., especially E. carpini and E. orientalis; Eriophyes spp., especially E. vitis; Hyalomma aspp., Ixodea spp., Olygonychus pratensis, Ornithodoros spp., Panonychus pp., especially P. ulmi and P. citri; Phyllocoptruta spp., especially P. oleivora; Polyphagotarsonemus spp., especially P. latus; Psoroptes spp., Rhipicephalus spp., Rhizoglyphus spp., Sarcoptes spp., Tarsonemus spp. and Tetranychus spp., in particular T. urticae, T. cinnabarinus and T. Kanzawai;

(14) the class Nematoda;
(A) nematodes selected from the group consisting of root knot nematodes, cyst-forming nematodes, stem eelworms and foliar nematodes;
(B) nematodes selected from the group consisting of Anguina spp.; Aphelenchoides spp.; Ditylenchus spp.; Globodera spp., Globodera rostochiensis; Heterodera spp., Heterodera avenae, Heterodera glycines, for example Heterodera schachtii or Heterodera trifolii; Longidorus spp.; Meloidogyne spp., for example Meoidogyne incognita or Meloidogyne javanica; Pratylenchus, for example Pratylenchus neglectans or Pratylenchus penetrans; Radopholus spp., for example Radopholus similis; Trichodorus spp.; Tylenchulus, for example Tylenchulus semipenetrans; and Xiphinema spp.; or
(C) nematodes selected from the group consisting of Heterodera spp., for example Heterodera glycines; and Meloidogyne spp., for example Meloidogyne incognita.

The inventive compositions are particularly useful for controlling cockroaches, termites, and ants.

Exemplary cockroaches controlled by the inventive compositions include Blattella germanica (L.), Blattella asahinai Mizukubo, Supella longipalpa (F.) Cariblatta lutea lutea (Saussure and Zehntner), Eurycotis floridana (Walker), Ischnoptera deropeltiformis (Brunner), Latiblattella rehni Hebard, Panchlora nivea (L.), Parcoblatta caudelli Hebard, Parcoblatta divisa (Saussure and Zehntner), Parcoblatta fulvescens (Saussure and Zehntner), Parcoblatta lata (Brunner), Blatta orientalis L., Periplaneta americana (L.), Periplaneta fuliginosa (Serville), Periplaneta australasiae (Fab.), Periplaneta brunnea Burmeister and Pycnoscelus surinamensis (L.).

### Soynuts

Soynuts, in general, are whole soybeans that have been soaked in water and then baked until browned. Soynuts can be found in a varies of flavors, including chocolate-covered. High in protein and isoflavones, soynuts are similar in texture and flavor to peanuts. You can find soynuts in natural food stores and through mail-order catalogs. One preferred embodiment of this invention is to use Soynut Butter. Soynut butter is made from whole soynuts that are then crushed and blended with soy oil and other ingredients. Soynut butter has a slightly nutty taste, significantly less fat than peanut butter and provides many other nutritional benefits as well. Soynut butter can be found in a few supermarkets, or through mail-order companies.

### Non-Monosaccharide Sugars

The sugars useful in this invention are the non-monosaccharides. In a preferred embodiment oligosaccharides (2-8 joined monosaccharides) are used, such as disaccharides, but in certain instances even polysaccharides (more than 8 joined monosaccharides) can be useful, especially with cellulose eating pests, such as, termites. Particularly preferred is sucrose and cellulose, especially in combination with each other to control wood eating pests such as termites. In one preferred embodiment a composition comprising both sucrose and cellulose is used to control termites and cockroaches. Cockroaches can tolerate certain levels of cellulose in the composition without significantly reducing the feeding activity of the roaches, while the higher cellulose level increases termite feeding activity. Results have indicated that adding an additional amount of cellulose (preferably alpha-cellulose or microcrystalline cellulose) in an amount of up to 20 percent (i.e. 20 parts added cellulose to 100 parts inventive composition) can be used. It is currently believed that up to 100 parts added cellulose to 100 parts inventive composition can be used successfully. Having one composition that can be used to control both types of pests in their separate environments is a great advantage of this particular embodiment.

### Pesticides

The pesticide can be any pesticide suitable for control of the particular pest.

Examples of suitable insecticides that may be used are:

(a) Pyrethroids, such as permethrin, cypemethrin, fenvalerate, esfenvalerate, deltamethrin, cyhalothrin, lambda-cyhalothrin, gamma-cyhalothrin, bifenthrin, fenpropathrin, cyfluthrin, tefluthrin, fish safe pyrethroids (for example ethofenprox), natural pyrethrin, tetramethrin, s-bioallethrin, fenfluthrin, prallethrin, 5-benzyl-3-furylmethyl-(E)-(IR,3S)-2,2-dimethyl-3-(2-oxothiolan-3-ylidenemethyl)cyclopropane carboxylate, or any of their insecticidally active isomers;

(b) Organophosphates, such as, methidathion, chlorpyrifos-methyl, profenofos, sulprofos, acephate, methyl parathion, azinphos-methyl, demeton-s-methyl, heptenophos, thiometon, fenamiphos, monocrotophos, profenofos, triazophos, methamidophos, dimethoate, phosphamidon, malathion, chlorpyrifos, chlorpyrifos-methyl, phosalone, terbufos, fensulfothion, fonofos, phorate, phoxim, pirimiphos-methyl, pirimiphos-ethyl, fenitrothion, fosthiazate or diazinon;

(c) Carbamates (including aryl carbamates), such as fenoxycarb, alanycarb, pirimicarb, triazamate, cloethocarb, carbofuran, furathiocarb, ethiofencarb, aldicarb, thiofurox, carbosulfan, bendiocarb, fenobucarb, propoxur, methomyl or oxamyl;

(d) Benzoyl ureas, such as lufenuron, novaluron, noviflumuron, teflubenzuron, diflubenzuron, triflumuron, hexaflumuron, flufenoxuron or chlorfluazuron;

(e) Organic tin compounds, such as cyhexatin, fenbutatin oxide or azocyclotin;

(f) Pyrazoles, such as tolfenpyrad, pyridaben, tebufenpyrad and fenpyroximate;

(g) Macrolides, such as avermectins or milbemycins, for example abamectin, emamectin benzoate, ivermectin, milbemycin, spinosad or azadirachtin;

(h) Hormones or pheromones;

(i) Organochlorine compounds such as endosulfan, benzene hexachloride, DDT, chlordane or dieldrin;

(j) Amidines, such as chlordimeform or amitraz;

(k) Fumigant agents, such as chloropicrin, dichloropropane, methyl bromide or metam;

(l) Chloronicotinyl compounds such as diofenolan, clothianidin, thiacloprid, imidacloprid, thiacloprid, acetamiprid, nitenpyram or thiamethoxam;

(m) Diacylhydrazines, such as halofenozide, tebufenozide, chromafenozide or methoxyfenozide;

(n) Diphenyl ethers, such as diofenolan or pyriproxifen;

(o) Indoxacarb;

(p) Chlorfenapyr;

(q) Pymetrozine;

(r) Diafenthiuron;

(s) Toxins of microbial origin such as B.acillus thuringiensis endo- or exotoxins;

(t) Phenylpyrazoles such as fipronil, vanilliprole, etiprole or acetoprole; or

(u) Pyridalyl.

In addition to the major chemical classes of pesticide listed above, other pesticides having particular targets may be employed if appropriate for the intended utility of the inventive composition. For instance, selective insecticides for particular crops, for example stemborer specific insecticides (such as cartap) or hopper specific insecticides (such as buprofezin) for use in rice may be employed. Alternatively insecticides or acaricides specific for particular insect species/stages may also be included in the inventive compositions (for example acaricidal ovo-larvicides, such as clofentezine, flubenzimine, hexythiazox or tetradifon; acaricidal motilicides, such as dicofol or propargite; acaricides, such as acequinocyl, fenazaquin, spirodiclofen, etoxazole, bromopropylate or chlorobenzilate; or growth regulators, such as hydramethylnon, cyromazine, methoprene, chlorfluazuron or diflubenzuron).

Examples of suitable insecticide synergists insecticides that may be used as a further active ingredient in the inventive compositions include piperonyl butoxide, sesamex, safroxan and dodecyl imidazole.

Specific examples of preferred pesticides are thiamethoxam, abamectin, emamectin benzoate, spinosad, chlorpyrifos, chlorpyrifos-methyl, profenofos, lufenuron, indoxacarb, hydramethylnon, lambda-cyhalothrin, pymetrozine, pirimicarb, methidathion, imidacloprid, acetamiprid, thiacloprid, fipronil, flufenoxuron, methoxyfenozide, chlorfenapyr, pyridaben, novaluron, noviflumuron, pyridalyl, propargite, sulfuramid, and piperonyl butoxide.

The pesticide can be microencapsulated wherein the microcapsule is semipermeable in the absence of free water and impermeable in a wet environment. This prevents the loss of pesticide by leaching, but permits release when the capsules are physically crushed, as during the act of chewing by pests. By using microencapsulated pesticides, the only substantial release of pesticide in the pest habitat is within the alimentary tracts of the target organisms. If the threat of leaching is not a factor or the pesticide is not repellent, it can be mixed directly into the inventive corn position.

In general the amount of pesticide to use is not critical. Amounts from 0.001 to 50 weight percent based on the weight of the inventive composition can be used.

### Preparation, Use, and Other Potential Ingredients

It should be readily noted that the inventive compositions should be substantially free of peanuts or tree nuts. The phrase “substantially free or peanuts or tree nuts” means that a ordinary person having a allergy to peanuts or tree nuts will not have anaphylaxis reaction to a compound when that person is exposed to such compound.

In a preferred embodiment the inventive compositions are hydrodynamic and function well in harsh microclimates or dynamic microclimates, such as an outdoor environment subject to typical circadian influences of temperature and moisture (See U.S. Pat. No. 5,968,540 the entire disclosure of which is hereby incorporated by reference). Under conditions of high moisture content in the air, the inventive compositions absorb water, then release it under more xeric conditions. Consequently, the inventive compositions in this one preferred embodiment continually charge and discharge moisture, which is one of the key components for arthropod survival. This release of moisture commonly occurs as temperatures rise with a concomitant drop in humidity. Higher temperatures increase the metabolism of insects. Subsequently, they have an increased need for food and for a good moisture provider.

In one preferred embodiment the inventive composition is in the form of a bait. The baits of the present invention are developed against highly preferable food substrates so that it is strongly attractive to well-fed insects. They contain several food components, that when combined, provide unexpected results in attractiveness and hydrodynamics. Flowable bait formulations can be made and delivered from a syringe- or tube-configuration and use of small-aperture adapters allows the bait to be placed strategically in inaccessible areas, providing a high safety factor.

Any pesticide can be used as the active ingredient. Also, because the matrix is so hydrodynamic, it can be used as a substrate for biological control agents that commonly have high moisture requirements such as, for example, nematodes. A formable bait can be placed in any type of known bait station. It can also be applied to a rough surface, such as for example any type of mesh screening, such as for example wire, vinyl, fiberglass, aluminum, etc.; and applied to any surface.

To further increase the hydrodynamic character of the baits, high fructose corn syrup and glycerin are included with pregelatinized starches in the bait formulation. The use of a pregelatinized starch in the presence of glycerin forms a glycerostarch complex that greatly maintains pliability and adhesiveness of the material over time. This results in a bait that can be used under broad environmental conditions that include horizontal and vertical surfaces under changeable microclimates such as, for example, commercial kitchens characterized by stainless steel surfaces with high ambient temperatures and humidities.

Optional ingredients to the bait include a preservative to retard fungal growth and a protectant such as a bittering agent to provide a safety factor for exposed bait.

An attractant is defined as any substance or combination of substances which will lure pests, especially a broad spectrum of cockroach species and other insects. The attractants include, for example, corn distiller's dried grains with solubles, herein after referred to as C-DDGS, etc. and combinations thereof. U.S. Pat. No. 4,988,510 (Brenner et al), herein incorporated by reference in its entirety, discloses that corn distiller's dried grains (C-DDGS) with solubles obtained from nonbeverage alcohol production, is highly effective as a bait for most species of peridomestic cockroaches but is not attractive to mammals such as dogs, cats, raccoons, and wood rats. The most preferred C-DDGS, for the purposes of this disclosure, is DDG (distiller's dried grains with solubles) from MPG Ingredients of Illinois (Pekin Ill. 61555) which is strongly preferred by insects.

Humectants useful in the present invention include, for example, any hygroscopic substance or combination of substances that draw moisture from the air, allowing the bait formulation to remain relatively moist and pliable. Sugars such as for example high fructose corn syrup, polyhydroxy alcohols such as glycerin, combinations thereof, etc. are exemplary of the substances useful for this purpose. Some humectants, such as sugars, provide the further advantage of enhancing the attractiveness of the bait. A most preferred humectant is a combination of glycerin and corn syrup wherein the corn syrup is 95% fructose (Archer Daniels Midland (ADM) high fructose corn syrup).

Gel formers for use herein provide an elastic, cohesive matrix that holds the attractant together in combination with other bait ingredients. Any gelling agent that is not repulsive to pest such as insects can be used, provided that the resultant matrix freely releases the aromatic elements of the attractants. Examples of useful gelling agents include pregelatinized wheat starch, found to be superior to all other starches; pregelatinized tapioca, pregelatinized potato, and pregelatinized corn starch. Corn is also found to be an excellent starch for a food attractant. The starches useful in the invention include, for example, pregelatinized wheat starch such as for example PAYGEL®. (ADM Decatur, Ill. 62549) pregelatinized tapioca, such as for example STA-SLIM 150®. (A. E. Staley, Decatur Ill. 62525) pregelatinized potato, such as for example STA-SLIM 142®. (A. E. Staley) pregelatinized corn starch such as for example MIRA-GEL® etc. These starches are used both for the flowable and the formable baits. The most preferred gelling agent is PAYGEL 290®. (ADM ARKADY, Olathe Kans. 66061). When a formable bait is desired, a second gel former is added. This second gel former includes any animal gelatin such as, for example, pork, beef, horse, etc. Pork gel (Rousselot Inc. Debuque, Iowa 52001) is most preferred.

Preservatives are optional in the baits of the invention but are recommended for baits used in very humid or moist conditions. Examples of preservatives useful in the present invention are 1,2-benzisothiazolin-3-one (PROXEL GXL®, Avecia Inc. Wilmington, Del. 19850) methyl paraben (p-hydroxybenzoic acid methyl ester) and propyl paraben (n-propyl p-hydroxybenzoate). Other known fungistats would also be effective in increasing the longevity of the bait and retarding mold growth.

Each component of the inventive compositions should be present in an effective amount. The expression “effective amount” is defined herein to mean that amount which is necessary to achieve the intended result of the component in question. For, example, an effective amount of the pesticide is that level or concentration which will kill significantly more target insects when the bait is consumed than when an equivalent amount of bait is consumed without the insecticide present.

On a weight basis the ratio of soynut:sugar (non-monosaccharide); should be 1 part soynut to 0.01 parts to 0.50 parts sugar (non-monosaccharide). In a preferred embodiment, when soynut butter is used, the weight ratio of soynut butter:sugar (non-monosaccharide) should be 1 part soynut butter to 0.1 parts to 0.3 parts sugar (non-monosaccharide). However, in general the amount of soynut, preferably soynut butter, is greater than the amount of (non-monosaccharide) sugar and these ratios can be varied widely, in order to attract a certain pest.

In a preferred embodiment, on a dry weight basis, the components of a bait composition optional ingredients will typically be present in about the following amounts:

(a) 5-90%, 10-60% preferred, and 10-35% most preferred, for the attractant;

(b) 0.1-20%, 5-60% preferred, and 40-60% most preferred, for the humectant;

(c) 1-30%, 1-20% preferred, and 2-15% most preferred, for the gel former; and

(d) 0-5% preferred and 0-2% most preferred, for the protectant.

To prepare the inventive compositions. the soynuts, sugar (non-monosaccharide), and pesticide and other desired components are mixed together to form a homogenous or heterogeneous mixture. Generally, the more coarse the soynuts the more heterogeneous the mixture. The order of addition is not consider to be critical.

To apply a preferred embodiment of the inventive compositions, a flowable bait can be dispensed from a syringe- or tube-configuration and the use of small-aperture adapters allows the bait to be placed strategically in inaccessible areas. A formable bait can be rolled and cut into any shape and size. It can be placed in any type of bait station or applied to any type of adhering surface such as for example applying it to a mesh screen, VELCRO, etc., and attached to any surface.

The Headings used herein are meant to be as a guide and not meant to be used to interpret the scope of the invention.

### EXAMPLES

These examples are provided to illustrate the invention. They are not to be used for limiting the scope of the invention.

### Example A

### Preparation of Insecticide Concentrate

An insecticide concentrate was prepared as follows: 615 grams of noviflumuron; 3.69 grams of Dow Corning Antifoam B (antifoam); 127.92 grams of Pluronic P-104 (dispersant); 8.61 grams of Proxel GXL (protectant) and 474.78 grams of water were milled together to form an insecticide concentrate.

### Example One

### Preparation of an Inventive Composition

An inventive composition in a preferred embodiment was made.

All the following additions were conducted by mixing the components together. To 10.13 grams of water was added 0.49 grams of sucrose. This was followed by the addition of 0.50 grams of insect concentrate (See Example A). This was followed by the addition of 0.10 grams of Proxel GXL. This was followed the addition of 4.14 grams of glycerin (Glycerin 96% USP Dow Chemical Co. Midland, Mich. 48674). This was followed by the addition of 18.68 grams of fructose corn syrup (CornSweet 95 High Fructose Corn Syrup, ADM Decatur Ill. 62549). This was followed by the addition of 2.59 grams of Paygel 290 and 10.95 grams of DDG. This was followed by the addition of 2.49 grams of soynut butter (The SoyNut Butter Co, Glenview, Ill. 60025). The mixture was mixed until substantially homogenous.

### Example Two

### Peanut Butter Vs. Soynut Butter (without Non-Monosaccharide Sugar) Vs. Inventive Composition in Preferred Embodiment (Soynut Butter with Non-Monosaccharide Sugar)

This is a paired comparison test of the above compositions exposed to mixed populations of German cockroach and tested as follows.

The Peanut Butter Composition was made as follows. All the following additions were conducted by mixing the components together. To 10.62 grams of water was added 0.50 grams of insect concentrate (See Example A). This was followed by the addition of 0.10 grams of Proxel GXL. This was followed the addition of 4.14 grams of glycerin (Glycerin 96% USP, The Dow Chemical Co., Midland, Mich. 48674). This was followed by the addition of 18.68 grams of fructose corn syrup (CornSweet 95 High Fructose Corn Syrup, ADM, Decatur, Ill. 62549). This was followed by the addition of 2.59 grams of Paygel 290 and 10.95 grams of DDG. This was followed by the addition of 2.49 grams of Peanut butter (The J. M. Smucker Co., Orrville, Ohio 44667). The mixture was mixed until substantially homogenous.

The Soynut Butter Composition was made as follows. All the following additions were conducted by mixing the components together. To 10.62 grams of water was added 0.50 grams of insect concentrate (See Example A). This was followed by the addition of 0.10 grams of Proxel GXL. This was followed by the addition of 4.14 grams of glycerin (Glycerin 96% USP, The Dow Chemical Co., Midland, Mich. 48674). This was followed by the addition of 18.68 grams of fructose corn syrup (CornSweet 95 High Fructose Corn Syrup, ADM, Decatur, Ill. 62549). This was followed by the addition of 2.59 grams of Paygel 290 and 10.95 grams of DDG. This was followed by the addition of 2.49 grams of Soynut butter (The SoyNut Butter Co, Glenview, Ill. 60025). The mixture was mixed until substantially homogenous.

The tests were conducted in a 8.3-L rectangular plastic container with choice testing sites and also having PVC harborage and water vials. The temperature was held at 25° C. and the RH was held at 50-60%.

The desire compositions in weigh trays (2 g) were placed on opposite sides of the arena. All formulations contained 0.5% noviflumuron. One hundred German cockroaches per replicate (80 mid-stage nymphs+10 adult males+10 adult non-gravid females) were used. There were six reps per choice test. Consumption on each bait measured after 7 days of exposure.

As shown in TABLE 2-1, the peanut butter composition was significantly preferred over the soynut butter alternative. The calculated palatability ratio showed 1.5× greater consumption of the peanut butter bait. However, there was a statistically neutral feeding response when the Inventive Composition was compared to the peanut butter bait, with nearly identical consumption of each formulation.

TABLE 2-1
Feeding response of German Cockroach

| | mg consumed after | |
|---|---|---|
| | 7 days | |
| Choice | Mean ± SEM | Palatability Ratio |
| Peanut Butter (PB) vs. | 465.50 ± 23.2 a | PB/SB |
| Soynut Butter (SB) | 301.50 ± 45.5 b | 1.54 |
| | (p value = 0.011) | |
| PB vs. | 326.60 ± 32.4 a | PB/SBS |
| Inventive Composition | 339.70 ± 37.9 a | 0.96 |
| SB + 1% sucrose (SBS) | (p value = 0.717) | |

This shows that soynut butter alone is not able to attract cockroaches alone, but unexpectedly, soynut butter with added sucrose (a disaccharide) is attractive to cockroaches. This is in spite of the fact that significant amount of monosaccharide were used in each composition (Fructose corn syrup).

### Example Three

### Inventive Vs. Commercial

This is a paired comparison between two different bait formulations on mid-stage American cockroach nymphs, tested as follows.

The tests were conducted in a 8.3-L rectangular plastic container with choice testing sites and also having PVC harborage and water vials. The temperature was held at 25° C. and the RH was held at 50-60%.

MAXFORCE was used as the commercial comparative composition. At the time of this experiment it was a leading product in this field. A preferred embodiment of our inventive composition was made in accordance with Example One.

The desire compositions in weigh trays (2 g) were placed on opposite sides of the arena. All formulations contained 0.5% Noviflumuron. Twenty American cockroach nymphs per replicate. There were five reps per choice test. Consumption on each bait measured after 2 days of exposure.

As shown in TABLE 3-1, American cockroach nymphs showed that when compared to MAXFORCE, an inventive formulation was overwhelmingly preferred, with little or no consumption measured on MAXFORCE.

TABLE 3-1
Feeding response of American cockroach to bait choices.

| | mg consumed | |
|---|---|---|
| | after 2 days | Palatability Ratio |
| Choice | Mean ± SEM | Inventive/MAXFORCE |
| Inventive vs. | 144.7 ± 41.6 a | ∞ |
| MAXFORCE | 0.0 ± 0.0 b | |
| | (p value <0.0001) | |

We claim:

1. A composition comprising:
(a) soynuts;
(b) at least one non-monosaccharide sugar; and
(c) at least one pesticide.

2. A composition according to claim 1 further comprising at least one attractant.

3. A composition according to claim 2 further comprising at least one humectant.

4. A composition according to claim 3 further comprising at least one gel former.

5. A composition according to claim 4 further comprising at least one protectant.

6. A composition comprising:
(a) soynut butter;
(b) at least one a non-monosaccharide sugar; and
(c) at least one pesticide.

7. A composition according to claim 6 further comprising at least one attractant.

8. A composition according to claim 7 further comprising at least one humectant.

9. A composition according to claim 8 further comprising at least one gel former.

10. A composition according to claim 9 further comprising at least one protectant.

11. A process comprising applying a composition according to claim 1 to a locus where there is at least one type of pest, wherein the amount applied to said locus is effective to control said at least one type of pest in said locus.

12. A process according to claim 11 wherein said at least one type of pest includes at least cockroaches.

13. A process according to claim 11 wherein said at least one type of pest includes at least termites.

14. A process according to claim 11 wherein said at least one type of pest includes at least ants.

15. A process according to claim 11 wherein said at least one type of pest includes at least rodents.

16. A process comprising mixing components (a), (b), and (c) of claim 1 to produce a composition according to claim 1.
